(19) United States
(12) Patent Application Publication
(10) Pub. No.: US 2020/0113035 A1
(43) Pub. Date: Apr. 9, 2020

(54) LIGHTNING STRIKE AND OVERVOLTAGE ALERTING

(71) Applicant: SIGNIFY HOLDING B.V., EINDHOVEN (NL)

(72) Inventors: JAN EKKEL, NOORD BRABANT (NL); HARRY BROERS, 'S-HERTOGENBOSCH (NL); MAURICE HERMAN JOHAN DRAAIJER, ITTERVOORT (NL); WEI PIEN LEE, EINDHOVEN (NL); RUBEN RAJAGOPALAN, NEUSS (DE)

(21) Appl. No.: 16/614,597

(22) PCT Filed: May 8, 2018
(86) PCT No.: PCT/EP2018/061783

§ 371 Date: Nov. 18, 2019

(30) Foreign Application Priority Data
May 18, 2017 (EP) 17171638.4

(51) Int. Cl. H05B 47/20; G06Q 10/00; G01W 1/16

(52) U.S. Cl. CPC H05B 47/20; G01W 1/16; G06Q 10/20

(57) ABSTRACT

The described embodiments relate to systems, methods, and apparatuses for identifying when one or more components of a luminaire (114) in a network of luminaires has malfunctioned as a result of an electrical event (112), and determining how neighboring luminaires (106) have been affected. An electrical event such as an overvoltage or transient can damage component(s) of luminaires that are closest to a point of origin of the electrical event. However, luminaires located further away from the point of origin can also be affected. Estimating such damage can be useful for planning maintenance of the luminaires and/or their components. Furthermore, when luminaires are equipped with the ability to collect data (220) related to electrical events, such as lightning strikes, their collected data can be provided as a service for assessing damage to nearby connected devices, and predicting future electrical events.

### TECHNICAL FIELD

The present disclosure is directed generally to detecting and predicting electrical events that can damage connected devices. More particularly, the systems, methods, and apparatuses described herein relate to assessing the effects of electrical events on components of luminaires and other devices using collected data related to overvoltages and transients.

### BACKGROUND

Electrical events such as lightning strikes can result in catastrophic damage to connected devices within an area of the lightning strikes. However, oftentimes damage to devices may not be completely obvious as such electrical events may only cause minor damage to surrounding devices. As a result, maintenance of devices, such as street lights, can be neglected by municipalities that are only able to determine when a street light has been rendered completely inoperable as a result of some electrical event. In some cases, scheduling of maintenance can be inefficient when municipalities or device operators are unable to make predictions about when certain devices in their geographic area will fail.

### SUMMARY

The present disclosure is directed to systems, methods, and apparatuses for predicting and diagnosing damage to a luminaire using data collected by a network of luminaires. Generally, in one aspect, a method is set forth for tracking an operating lifetime of one or more components of a luminaire using electrical event data. The method can include steps of determining that a network of luminaires has been affected by an electrical event, determining a location where the electrical event originated, and identifying, in the network of luminaires, a luminaire that is a distance away from where the electrical event originated. The method can further include steps of generating an estimate of reduction in lifetime of one or more components of the luminaire according to the distance of the luminaire from the location of where the electrical event originated, and updating an index of lifetimes for luminaire components in the network of luminaires according to the generated estimate of reduction in lifetime. The electrical event can be an overvoltage condition or signal transient measured at one or more luminaires in the network of luminaires. Generating the estimate of reduction in lifetime can include accessing a database that includes historical electrical event data. The database can correlate the historical electrical event data to changes in lifetimes of luminaire components. Determining the location of where electrical event originated can include collecting electrical event data from the network of luminaires, determining, based on the electrical event data, a most proximate luminaire to the electrical event, and determining a coordinate of the most proximate luminaire. The method can further include updating a topographic mapping (316) of electrical events in a geographic area to include the electrical event.

In other embodiments, a non-transitory computer-readable medium is set forth as storing instructions that when executed by one or more processors of a computing device, cause the computing device to perform steps that include detecting malfunction of a first luminaire of a network of luminaires. The steps can also include receiving weather data corresponding to weather activity in a geographic area that includes the first luminaire and correlating at least some of the weather activity to the malfunction of the first luminaire. The steps can further include identifying a second luminaire of the network of luminaires located in the geographic area and determining an effect of the correlated weather activity on the second luminaire. Additionally, the steps can include estimating a change in lifetime of one or more components of the second luminaire based on the effect of the correlated weather activity. The correlated weather activity can be lightning strikes and the weather data identifies multiple lightning strikes that have occurred in the geographic area. The effect of the correlated weather activity can be an overvoltage experienced by one or more components of the second luminaire. The steps can further include accessing a database that correlates overvoltages to changes in lifetime for a luminaire. Detecting malfunction of the first luminaire of the network of luminaires can include detecting that a radio-frequency signal provided by the first luminaire is impeded.

In yet other embodiments, a lighting apparatus is set forth as including one or more processors, and memory configured to store instructions that when executed by the one or more processors, cause the one or more processors to perform steps that include identifying a location of a previous electrical event that has affected a first device operating in the location. The steps can also include determining that a second device is within a predetermined distance of the location and shares an operating feature with the first device that makes the second device susceptible to damage from electrical events. The steps can further include providing a notification that identifies the second device as being at risk for damage from a future electrical event. The first device can be a luminaire and the operating feature is a memory device that is susceptible to damage from electrostatic discharge. The steps can also include receiving, from the first device, electrical event data collected by the first device, wherein the electrical event data identifies signal transients occurring in the first location, and generating an estimate for a reduction in operating lifetime of the second device based at least on a distance of the second device from the location.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, tribo luminescent sources, sonoluminescent sources, radio luminescent sources, and luminescent polymers.

The terms “lighting fixture” and “luminaire” are used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller, which employs one or more microprocessors that may be programmed using software (e.g., machine code) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or machine code) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a diagram of a network of luminaires that includes a malfunctioning luminaire that has been damaged as a result of a harmful electrical event, such as a lightning strike.

FIG. 2 is a system for using luminaires to collect and share data related to electrical events that can diminish the lifetime of the luminaires.

FIG. 3 illustrates a diagram of a remote management device that can make predictions about the lifetimes of devices affected by electrical events such as transients and overvoltages.

FIG. 4 illustrates a method for tracking changes in lifetimes of one or more components of a luminaire according to the occurrence of electrical events in a geographic area.

FIG. 5 illustrates a method for estimating changes in lifetimes of one or more components of a luminiare according to weather data corresponding to a geographic area.

FIG. 6 illustrates a method for providing notifications related to electrical events occurring in a geographic area.

### DETAILED DESCRIPTION

The described embodiments relate to systems, methods, and apparatuses for predicting and diagnosing damage to a luminaire using data collected by a network of luminaires. A damaged luminaire can be victim to an overvoltage event, such as a lightning strike or a transient event caused by excessive switching. Although surge protection devices can be employed to protect luminaires from harmful electrical events, such surge protectors may not protect from transients caused by excessive switching. Furthermore, when the damaged luminaire is a smart luminaire with additional circuitry beyond a lighting circuit, the cost of replacing the damaged luminaire can be more expensive than less advanced luminaires. Additionally, the cost of sending maintenance crews out to replace luminaires can also be an excessive service expense that may be unnecessary at times depending on the extent of damage to the luminaires. In order to make the service process more efficient, circumstantial information related to the cause of damage to a luminaire can be gleaned from other luminaires in a network of luminaires.

A network of luminaires can be connected over a geographic area for exchanging information between the luminaires, as well as communicating information between remote computing devices, such as a backend server. If a lightning strike occurs in the geographic area, a luminaire on the network can exhibit a complete failure or at least some loss of function, such as a lack of ability to communicate and/or illuminate. Such function loss can also be the result of an improper installation or solar power potential that causes the grid to increase a power output above a nominal level. Any other luminaires on the network of luminaires can detect the overvoltage event through interpolation of information or signals shared between luminaires. For example, each luminaire can include a driver and/or diagnostic module that can provide information related to the performance, usage, life-time, damage events, and/or any other data associated with the operation of a luminaire.

In some embodiments, each luminaire in a network of luminaires can be configured to provide a radio-frequency (RF) signal to one or more other luminaires in the network of luminaires. The RF signal can propagate from one luminaire to other luminaires in order that delay and/or propagation can be determined for each luminaire that initiates an RF signal and/or for each location corresponding to the initiating luminaire. The RF signal can be used to determine a distance between luminaires and can be sent wirelessly or over power lines. In this way, when a luminaire is destroyed by a lightning strike, a location of the affected luminaire can then be identified according to a previously measured propagation signal. The measured propagation signal levels can be stored by each luminaire and/or stored by a remote device that is in communication with the network of luminaires, such as a backend server. Other methods of identifying a location of a luminaire can include power line communications, wireless communications via a mesh network, Bluetooth, and/or general packet radio service (GPRS).

The network of luminaires and backend server can correspond to a lighting management system that can be calibrated at different times in order to more accurately identify locations and properties of harmful electrical events. Calibration can be performed by reinitializing an RF signal from each luminaire in the network of luminaires. Signal levels and delays can then be remeasured and stored in association with locations in the geographic area where the network of luminaires is located. In some embodiments, the lighting management system can be preloaded with data related to a power grid that is providing power to the network of luminaires, and/or the luminaires can retrieve power grid data, such as network topology, according to the similarity in sensor signals of various poles. For example, the preloaded data can include a power grid layout, cable dimensions, cable impedances, and/or any other data suitable for use when determining signal levels as a function of frequency and/or location of an electrical event. In other embodiments, the lighting management system can detect event data for determining the cause of damage to luminaires. For example, the lighting management system can compare an amount of power being supplied to a network of luminaires with an amount of power available at poles nearby different luminaires. Differences in such power amounts can be indicative of damaging electrical events that can affect the operation of luminaires. Other data can also be collected by the lighting management system, including information related to switching, load changes, indirect lightning strikes, direct lightning strikes, electrostatic discharges, short circuits, earth faults, temperature, tripping of fuses, and/or locally generated solar power voltage. For example, temperature data can be collected at each luminaire and used for more accurately identifying changes in frequencies of signals between luminaires, which can change with temperature. Temperature data can also be used to help determine lengths between cables, which can also vary with temperature.

The lighting management system can determine the causes of luminaire failures, and communicate, to municipalities, information related to the causes for scheduling luminaire maintenance. Such communications can prevent unnecessary maintenance trips when the cause of damage to a luminaire would not have otherwise been known. Aside from maintenance, such information can be used to eliminate energy theft, which can be evidenced by undervoltage events detected by the lighting management system. Cable theft can also be identified and prevented using such communications from the lighting management system. For example, cable theft can be determined by measuring cable reflection timing, which can provide an indication of where cable theft has occurred. Should a cable theft be anticipated, the lighting management system can alert authorities before the power grid is affected by the cable theft.

The lighting management system can include a number of devices for effectuating the embodiments provided herein. For example, each of the luminaires in the network of luminaires can include a controller that operates a driver or diagnostics module for monitoring overvoltage and transient events. Each luminaire can further include a memory for storing data related to the overvoltage and transient events, and a communications module that can communicate data and signals between luminaries and remote devices. The lighting management system can further include a backend server or other remote computing device that can detect when a luminaire of the network of luminaires is unresponsive. The remote computing device can also collect overvoltage and/or transient detection data provided by the network of luminaires. This data can be used in one or more algorithms operating at the remote computing device for diagnosing issues corresponding to an unresponsive luminaire. For example, the remote computing device can operate an algorithm for identifying a location of a damaged luminaire using data provided by the network of luminaires. An algorithm can also be employed by the remote computing device for determining where an overvoltage and/or transient event originated. Such determined information related to harmful electrical events can be stored as historical data that can be used for making decisions about whether to power off certain luminaires that may be in an area that is at risk of future harmful electrical events. By powering off the luminaires to prevent potential damage from electrical events, the lighting management system can protect the infrastructure of a city or area without comprising public safety.

The historical data collected by the lighting management system can also be used to improve the algorithms employed by the lighting management system. For example, as new electrical events occur, the lighting management system can adapt to how the electrical events are changing. The lighting management system can provide feedback to other services such as a weather service or to a power provider, in order that they may use the feedback for their own operations. In some embodiments, the lighting management system can notify persons within a vicinity of the network of luminaires that they are in an area that is or will be affected by an electrical event, such as a lighting strike. The lighting management system can also notify such persons about upcoming maintenance and scheduled off times for the luminaires. Furthermore, the lighting management system can also share collected data with insurance companies and manufacturers that seek to know more about claims related to product failures caused by electrical events. Alternatively, the lighting management system could provide collected data to advertisers who wish to promote device protection services to those in geographic regions that have been determined, by the lighting management system, to be more at risk for damaging electrical events. For example, homes having more connected devices can be at risk of damage from overvoltage and transient events, therefore homeowners can benefit from learning when such events are detected.

In other embodiments, the lighting management system can be tasked with monitoring undervoltage events in order to identify instances of energy theft. Undervoltage events can be associated with excessive voltage losses from impedance mismatches, excessive grid loads applied by consumers, industrial facilities such as factories, and/or businesses. The lighting management system can measure variations in a power supply (e.g., a power supply of 50 Hertz and 230 Volts) at various points in a city and identify locations corresponding to higher voltage drops. Such locations can correspond to energy theft when consumption values do not equal or otherwise correspond to meter values. In yet other embodiments, the lighting management system can be tasked with monitoring overvoltage events, in order to identify locations where power is injected back into the grid. Overvoltage events can occur when persons fraudulently attempt to maximize income from the grid when, for example, operating solar panels, an electric vehicle that supplies power back to the grid, or other energy harvesting system. Such overvoltage events, when occurring for extended periods of time, can affect luminaires lifetimes because they cause luminaires to operate out of their maximum voltage specification.

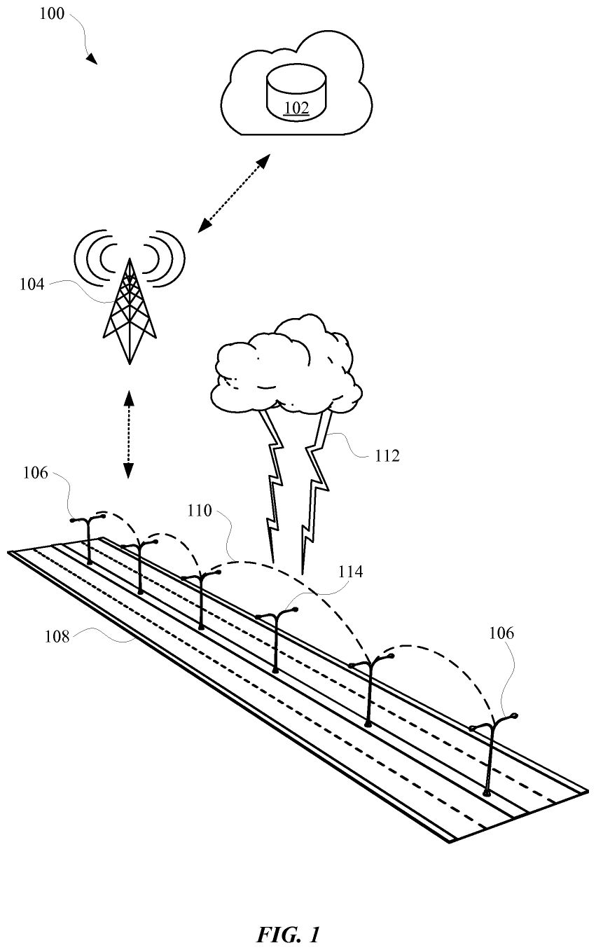

FIG. 1 illustrates a diagram 100 of a network of luminaires 106 that include a malfunctioning luminaire 114 that has been damaged as a result of a harmful electrical event, such as a lightning strike 112. Depending on a proximity of each luminaire 106 to the electrical event, a luminaire 106 can experience some amount of performance degradation and a decrease in useful lifetime. For example, a direct lightning strike 112 to a luminaire 106 can cause a total loss of operation or some functionality, such as the ability to communicate signals 110, as illustrated in diagram 100 with respect to the malfunctioning luminaire 114. Furthermore, luminaires 106 that are proximate to the malfunctioning luminaire 114 can also exhibit some amount of degradation as a result of being near the electrical event. In order to track and predict such degradation, each luminaire 106 can be equipped with a computing device that can detect electrical events such as overvoltages, undervoltages, and transients. The computing device can also be equipped with one or more transmitters for communicating with other luminaires 106 in the network of luminaires 106. In this way, the luminaires 106 share data related to electrical events and identify luminaires 106 that have malfunctioned and, for example, are unable to communicate.

The transmitters of the luminaires 106 can communicate over a network 104 with a remote computing device 102 that can collect historical data related to the operations of the network of luminaires 106. For example, the remote computing device 102 can identify each luminaire 106 according to a geolocation of each luminaire 106 and create a geographic mapping of the network of luminaires 106. The remote computing device 102 can also collect electrical event data from the luminaires 106 and correlate the electrical event data with the geographic mapping of the luminaires 106. In this way, the remote computing device 102 is capable of identifying and tracking geographic regions that have electrical events that affect an operation of the luminaires 106. The remote computing device 102 can use this information to directly or indirectly control the operations of the network of luminaires 106 to avoid future damage from electrical events. The remote computing device 102 can also share this information with users and service providers that would like to be put on notice of which geographic areas are more susceptible to electrical events that cause device degradation.

Aggregation of electrical event data can be undertaken by the network of luminaires 106, which is capable of sharing electrical event data between luminaires 106 of the network. Such electrical event data can include transient event data that tracks the transients in the power signals received by the luminaires 106, and overvoltage data that tracks the changes in voltage received by the luminaires 106. The computing device of each luminaire 106 can include a diagnostics module that can track performance, usage, lifetime influencing events, maintenance events, and/or any other data that can influence an operation of a device. Furthermore, the computing device can track the performance and events affecting the other luminaires 106 in the network. Communications with other luminaires 106 can be performed over a radio frequency connection where signals 110 are transmitted and propagated across multiple luminaires 106. In this way, when a luminaire 106 in the network malfunctions, each luminaire 106 can be put on notice as a result of a lack of connection with the malfunctioning luminaire 114, or some other indication directly or indirectly provided by a luminaire 106 in the network of luminaires 106. For example, the malfunctioning luminaire 114 could have previously provided a radio frequency signal 110 to another luminaire 106 periodically at a particular signal level or at a particular time. If that signal level drops, or a time delay of the signal 110 occurs, simultaneous to an electrical event, such as a transient or lightning strike 112, the other luminaire 106 can generate data that identifies the malfunctioning luminaire 114 as being affected by the electrical event. The generated data can be transmitted over the network 104 to the remote computing device 102 for storage and further analysis.

In some embodiments, the luminaires 106 can track operational data and environmental data associated with the network of luminaires 106, and that data can be transmitted to the remote computing device 102 to determine whether an electrical event has occurred. For example, the remote computing device 102 can be preloaded with information related to a power grid that is supplying power to the network of luminaires 106. The information can include grid layout, cable lengths, cable impedances, and/or any other data associated with a power grid. The remote computing device 102 can use the preloaded data to determine whether changes in signals levels and/or signal delays actually correspond to harmful electrical events. Furthermore, the remote computing device 102 can track the types of events that are occurring and correlate those events to their locations of origin. For example, the types of events can include switching, load changes, indirect lightning strikes, direct lightning strikes, electrostatic discharges, short circuits, earth faults, tripping of fuses, solar power overvoltage, and/or any other electrical event that can damage a device connected to a power grid. It should be noted that any function performed by the remote computing device 102 can be performed by a computing device of a luminaire 106 on the network of luminaires 106.

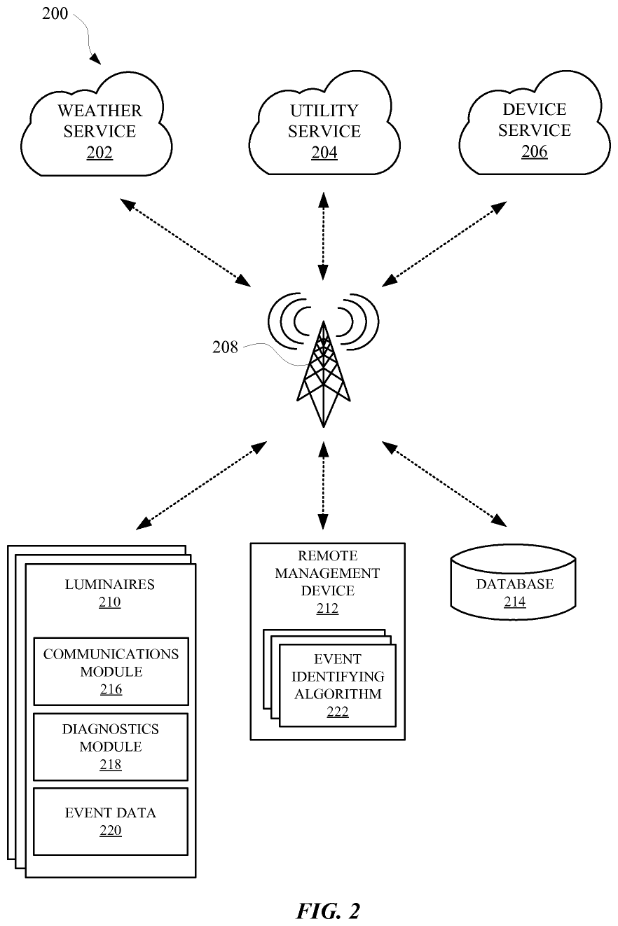

FIG. 2 is a system 200 for using luminaires to collect and share data related to electrical events that can diminish the lifetime of one or more components of the luminaires. A luminaire can include components such as ballasts, power supplies, lighting units, sensors, controllers, drivers, and/or any other component suitable for inclusion in a luminaire. In some embodiments, one or more of these components can be part of a lighting unit that is installed in a luminaire. The system 200 can include a network of luminaires 210 for illuminates geographic areas, as well as collecting and sharing data affecting operations of the luminaires 210. Each luminaire 210 can include a communications module 216, a diagnostics module 218, and stored event data 220. The communications module 216 can communicate with other luminaires in the network of luminaires 210 in order that data can be shared among the luminaires 210. The diagnostics module 218 can track performance related data of a luminaire 210 and provide the performance related data to the communications module 216 for sharing with other luminaires 210. In some embodiments, the diagnostics module 218 can track power related data in order to identify when a harmful electrical event (e.g., overvoltage and/or transients) has occurred. This data can be stored at the luminaire 210 as event data 220 and/or transmitted to a remote management device 212 for analysis.

The remote management device 212 can be in communications with the luminaires 210 and can determine when a luminaires 210 is unresponsive or otherwise malfunctioning in some way. Furthermore, the remote management device 212 can employ one or more event identifying algorithms 222 to identify harmful electrical events affecting the luminaires 210. For example, an event identifying algorithm 222 can use data such as global positioning system (GPS) data corresponding to a location of one or more luminaires 210, overvoltage values, undervoltage values, transient signal values, and/or any other data related to an operating environment of a luminaire 210. In some embodiments, the data can be collected by the luminaires 210 and/or the remote management device 212 and stored in a database 214 that is accessible to the luminaires 210, the remote management device 212, and/or any other device associated with the luminaires 210. The data can be used by an event identifying algorithm 222 to evaluate a cause of malfunction for one or more of the luminaires 210. Furthermore, the data can be used by an event identifying algorithm 222 to locate any damaged luminaires 210 and determine an extent of damage to the luminaires 210.

In some embodiments, an event identifying algorithm 222 of the remote management device 212 can use the collected data to create an index or mapping of electrical events to identify locations where devices are more or less susceptible to damage from such electrical events. In other embodiments, an event identifying algorithm 222 can use the data to track changes in luminaire lifetime predictions that result from the occurrence of harmful electrical events. For example, the lifetime of one or more components of a luminaire 210 can be more impacted by a direct lightning strike than a current or voltage transient that occurs infrequently. However, these events can be recorded nonetheless in order to make estimates regarding how a lifetime of one or more components of the luminaire 210 is changing as a result of such events. Luminaire lifetime data can then be shared with a utility service 204 such that maintenance of the luminaires 210 can be scheduled according to the luminaire lifetime data.

In some embodiments, data collected by the luminaires 210 related to electrical events can be shared with a weather service 202. Such data can include the intensity and location of lightning strikes, which can be used by the weather service 202 to advise their subscribers about weather activity resulting in electrical events. Furthermore, the weather service 202 can provide weather related data to the remote management device 212 for improving the event identifying algorithms 222.

In some embodiments, the remote management device 212 can communicate with a device service 206 that can use the data and analysis of the remote management device 212 to make predictions about a variety of different devices that can be affected by electrical events. For example, a connected home or vehicle can be susceptible to electrical events, which can result in damage to the devices connected within the home or electronics within a vehicle. Using the data from remote management device 212 regarding the causes of certain luminaire malfunctions, the device service 206 can make predictions about how certain consumer electronics, such as personal computers, cars, televisions, and appliances, will react to certain electrical events over time. The device service 206 can make decisions regarding how to operate the devices according to the collected data from the remote management device 212. For example, an appliance that is connected to the network 208 can receive instructions from the device service 206 for switching to a safe mode or low power mode during certain times or when certain electrical events are detected by the luminaires 210. Such instructions can protect the devices and save consumers money on maintenance and replacement. In some embodiments, the luminaires 210 can communicate directly with vehicles that are traveling along roads that are illuminated by the luminaires 210. The luminaires 210 can transmit collected data or relay analysis from the remote management device 212 in order to warn a drive of the vehicle about electrical events that might affect them. Furthermore, manufacturing companies can curb liability for certain damaged goods by using the collected data to identify causes of device malfunction, which might otherwise be blamed on a manufacturer error.

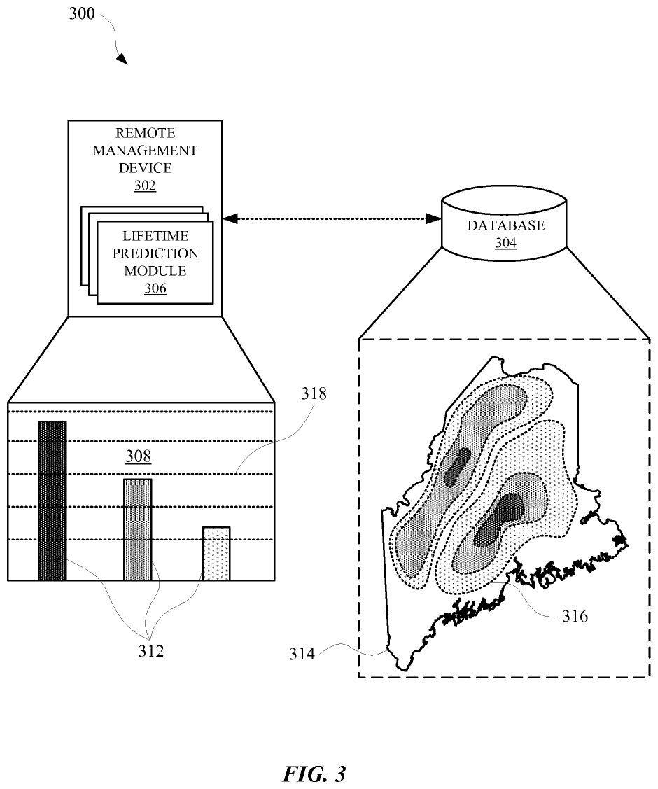

FIG. 3 illustrates a diagram 300 of a remote management device 302 that can make predictions about how the lifetimes of devices are affected by electrical events such as transients and overvoltages. Specifically, the remote management device 302 can communicate with a database 304 that can store data provided by the remote management device 302 and/or a network of luminaires. The data can be related to electrical events that can affect an operation of the network of luminaires and/or other devices located in a geographic area 314. The remote management device 302 can organize the data as an index or topographic mapping 316 that can allow the remote management device 302 to determine an intensity of electrical events and/or a frequency of electrical events in a geographic area 314. For example, more intense or more frequent electrical events can occur in the darker shaded regions of the geographic area 314.

The remote management device 302 can include a lifetime prediction module 306 that can use the index or topographic data to make predictions about how devices in the geographic area 314 will be affected by the electrical events. For example, as illustrated in chart 308, a quality 312 of an electrical event, whether the quality is intensity or frequency, can be correlated to an operating lifetime change 318 of a device such as a luminaire. Therefore, devices in a geographic area 314 having more intense or more frequent electrical events can require more frequent maintenance. The remote management device 302 can use the correlation between quality 312 of an electrical event and topographic data to advise municipalities of the geographic area 314 about the operating lifetime changes 318 of the devices they manage. Furthermore, the remote management device 302 can use the correlation between quality 312 of an electrical event and topographic data to communicate with consumers that operate devices in high risk areas. In this way, a user will be able to make more informed decisions about when to operate their devices and when to expect to have maintenance on their devices.

In some embodiments, the topographic data can be compiled from utility service data, which can include electrical event data corresponding to various electrical poles throughout the geographic area 314. For example, the darkest shaded regions can correspond to locations where lightning strikes of over 50 kilovolts were recorded, and the less dark shaded regions can correspond to locations where lightning strikes of less than 50 kilovolts were recorded. In some embodiments, the lifetime prediction module 306 can determine a distance that each device or luminaire is from each shaded region and determine an operating lifetime change 318 for each device or luminaire. In this way, the remote management device 302 can be aware of when a luminaire completely malfunctions, and when a luminaire is expected to malfunction in the future, thereby improving maintenance efficiencies. In some embodiments, the remote management device 302 can make predictions about when electrical events will occur, at least based on historical data related to when and where the electrical events have previously occurred. This information can be used by a utility service that make decisions regarding when to shut off luminaires in order to promote longevity of the luminaires without comprising public safety.

Furthermore, in some embodiments, the remote management device 302 can diagnose a cause of luminaire malfunction using the topographic data. For example, oftentimes the cause of malfunction of a luminaire may not be immediately known. However, because the remote management device 302 can store a location of the luminaire, the remote management device 302 can diagnose the malfunction as resulting from the luminaire being located in a region with higher quality electrical events. This diagnosis can be based on historical data, as well as real time data that is provided by luminaires that are proximate to the malfunctioning luminaire.

In some embodiments, the remote management device 302 can organize the topographic data to represent undervoltage conditions. The undervoltage conditions can be measured by sensors in the network of luminaires in order to locate areas where energy theft is occurring. By organizing the data in a topographic manner, the locations where undervoltage conditions are most prominent can be readily identified. Utility services can then be notified of the locations of such undervoltage conditions in order to eliminate any energy theft that might be occurring at the grid.

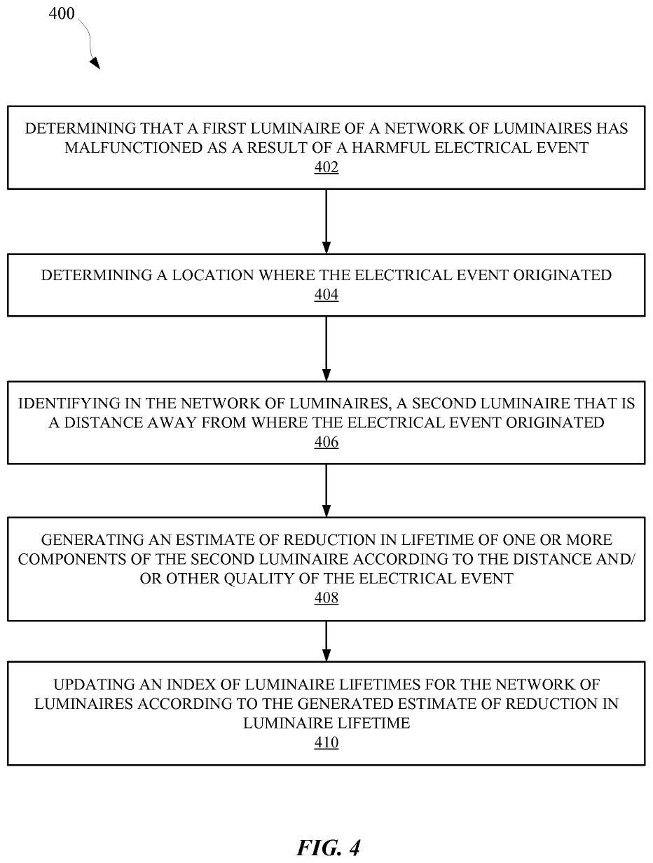

FIG. 4 illustrates a method 400 for tracking changes in lifetimes of one or more components of a luminaire according to the occurrence of electrical events in a location. The method 400 can be performed by a luminaire, a remote computing device, a controller, and/or any other computing device suitable for managing data. The method 400 can include a block 402 of determining that a first luminaire of a network of luminaires has malfunctioned as a result of a harmful electrical event. The determination at block 402 can be based on data gathered by one or more luminaires in the network of luminaires and/or remote computing devices that collect data related to electrical events. The electrical event can be an overvoltage, undervoltage, transient, lightning strike, load switch, and/or any other event that can affect a connected device. At block 404, a location of where the electrical event originated can be determined. The location of origin of the electrical event can be identified by first identifying a location of one or more luminaires that sensed the electrical event, and identifying a location of the luminaire that was closest to an impact zone of the electrical event or detected a greatest quality of the electrical event. At block 406, a second luminaire in the network of luminaires can be identified as being a distance away from where the electrical event originated. The location of the second luminaire can be identified by using GPS data gathered from the second luminaire and/or by measuring signal delays or signal propagation of a signal transmitted by the second luminaire. At block 408, an estimate of reduction in lifetime for one or more components of the second luminaire can be generated according to the distance and/or other quality of the electrical event. For example, if the second luminaire was located at the origin of the electrical event, the estimate of the lifetime of one or more components of the second luminaire can be reduced by more than 25%, or any other suitable percentage. Alternatively, if the second luminaire was not located at the origin of the electrical event, but was located a substantial distance away (e.g., 5 miles away), the estimate of lifetime of the one or more components of the second luminaire can be reduced by less than 25%, or any other suitable percentage. At block 410, an index of luminaire lifetimes for the network of luminaires can be updated according to the generated estimate of reduction in luminaire lifetime. In this way, the index can be used to schedule maintenance of luminaires and predict when other devices, connected near each luminaire in the network, will have issues related to the electrical events.

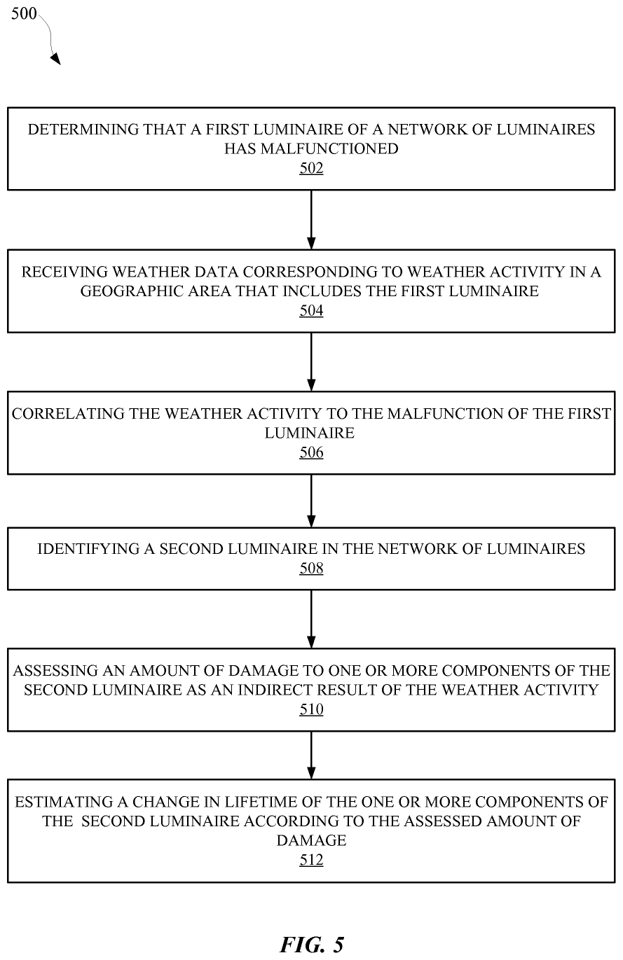

FIG. 5 illustrates a method 500 for estimating changes in luminaire lifetime according to weather data corresponding to geographic area. The method 500 can be performed by a luminaire, a remote computing device, a controller, and/or any other computing device suitable for analyzing data. The method 500 can include a block 502 of determining that a first luminaire in a network of luminaires has malfunctioned. The malfunction can be a complete lack of all functions of the first luminaire, or a loss of at least one function of the first luminaire, such as a loss of an ability to transmit signals. At block 504, weather data corresponding to weather activity in a geographic area that includes the first luminaire can be received. The weather data can include information regarding the occurrence of lightning strikes in the geographic area, humidity in the geographic area, temperature in the geographic area, and/or any other data related to weather. At block 506, the weather data can be correlated to the malfunction of the first luminaire. In other words, the weather data can be analyzed in order to determine that the weather activity was the cause of the malfunctioning of the first luminaire. For example, the weather data can identify a lightning strike that occurred in the same location and at the same time that the first luminaire began to malfunction, thereby suggesting the lightning strike was the cause of the malfunction.

At block 508, a second luminaire in the network of luminaires can be identified. The second luminaire can be identified as part of a standard operation in response to a determination that a luminaire in the network of luminaires has malfunctioned. At block 510, damage to the second luminaire as an indirect or direct result of the weather activity can be assessed. For example, separate functions of the second luminaire, such as illumination and communication, can be tested to determine whether they are exhibiting some amount of malfunction. Alternatively, an estimate of an amount overvoltage that was experienced by the second luminaire from the lightning strike can be determined, and the assessed amount of damage can be based on the estimated amount of overvoltage. At block 512, a change in lifetime of one or more components of the second luminaire can be estimated according to the assessed amount of the damage. For example, the change in lifetime for the one or more components can be a percentage reduction in a current estimate of lifetime, and the percentage reduction can be based on the type of weather activity, the distance from the first luminaire, the amount of overvoltage, a number of transients experienced by the second luminaire, the function lost at the second luminaire, and/or any other detail that can affect a lifetime of a luminaire. It should be noted that the term “lifetime” can correspond to amount of time that a device or component would normally operate without malfunctioning as the result of some unexpected catastrophic event or operating error.

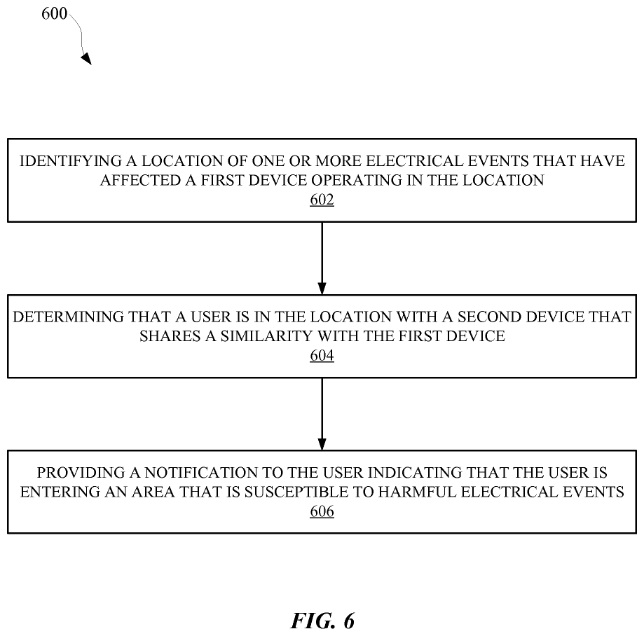

FIG. 6 illustrates a method 600 for providing notifications related to electrical events occurring in a geographic area. The method 600 can be performed by a luminaire, a remote computing device, a controller, and/or any other computing device suitable for providing notifications. The method 600 can include a block 602 of identifying a location of one or more electrical events that have affected a first device operating in the location. For example, the location can correspond to a block of a city and the first device can be a luminaire that illuminates a street. At block 604, a determination is made that a user is in the location with a second device that shares a similarity with the first device. For example, the first device and the second device can include a memory that can be susceptible to damage caused by electrostatic discharge. At block 606, the user can be notified that they are entering an area that is susceptible to harmful electrical events. In this way, the user can benefit from the collection of electrical event data and make decisions to protect their device based on the notification.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. A method for tracking an operating lifetime of one or more components of a luminaire using electrical event data, the method comprising:
determining that a network of luminaires has been affected by an electrical event;
determining a location where the electrical event originated;
identifying, in the network of luminaires, a luminaire that is a distance away from where the electrical event originated;
generating an estimate of reduction in lifetime of one or more components of the luminaire according to the distance of the luminaire from the location of where the electrical event originated; and
updating an index of lifetimes for luminaire components in the network of luminaires according to the generated estimate of reduction in lifetime; and
updating a topographic mapping of electrical events in a geographic area to include the electrical event.

2. The method of claim 1, wherein the electrical event is an overvoltage condition or signal transient measured at one or more luminaires in the network of luminaires.

3. The method of claim 1, wherein generating the estimate of reduction in lifetime includes:
accessing a database that includes historical electrical event data.

4. The method of claim 3, wherein the database correlates the historical electrical event data to changes in lifetimes of luminaire components.

5. The method of claim 1, wherein determining the location of where electrical event originated includes:
collecting electrical event data from the network of luminaires;
determining, based on the electrical event data, a most proximate luminaire to the electrical event; and
determining a coordinate of the most proximate luminaire.

6. (canceled)

7. A non-transitory computer-readable medium configured to store instructions that when executed by one or more processors of a computing device, cause the computing device to perform steps that include:
detecting malfunction of a first luminaire of a network of luminaires;
receiving weather data corresponding to weather activity in a geographic area that includes the first luminaire;
correlating at least some of the weather activity to the malfunction of the first luminaire;
identifying a second luminaire of the network of luminaires located in the geographic area;
determining an effect of the correlated weather activity on the second luminaire; and
estimating a change in lifetime of one or more components of the second luminaire based on the effect of the correlated weather activity.

8. The non-transitory computer readable medium of claim 7, wherein the correlated weather activity is lightning strikes and the weather data identifies multiple lightning strikes that have occurred in the geographic area.

9. The non-transitory computer readable medium of claim 7, wherein the effect of the correlated weather activity is an overvoltage experienced by one or more components of the second luminaire.

10. The non-transitory computer readable medium of claim 7, wherein the steps further include:
accessing a database that correlates overvoltages to changes in lifetime for a luminaire.

11. The non-transitory computer readable medium of claim 7, wherein detecting malfunction of the first luminaire of the network of luminaires includes:
detecting that a radio-frequency signal provided by the first luminaire is impeded.

12. A lighting apparatus, comprising:
one or more processors; and
memory configured to store instructions that when executed by the one or more processors, cause the one or more processors to perform steps that include:
identifying a location of a previous electrical event that has affected a first device operating in the location;
determining that a second device is within a predetermined distance of the location and shares an operating feature with the first device that makes the second device susceptible to damage from electrical events; and
providing a notification that identifies the second device as being at risk for damage from a future electrical event.

13. The lighting apparatus of claim 12, wherein the first device is a luminaire and the operating feature is a memory device that is susceptible to damage from electrostatic discharge.

14. The lighting apparatus of claim 12, wherein the steps further include: receiving, from the first device, electrical event data collected by the first device, wherein the electrical event data identifies signal transients occurring in the first location.

15. The lighting apparatus of claim 12, wherein the steps further include: generating an estimate for a reduction in operating lifetime of the second device based at least on a distance of the second device from the location.
